(19) United States
(12) Patent Application Publication
(10) Pub. No.: US 2015/0116491 A1
(43) Pub. Date: Apr. 30, 2015

(54) PRIVATE AND AUTOMATIC TRANSMISSION OF PHOTOGRAPH VIA OCCUPANT'S CELL PHONE FOLLOWING IMPACT EVENT

(71) Applicant: Ford Global Technologies, LLC, Dearborn, MI (US)

(72) Inventors: Mark A. Cuddihy, New Boston, MI (US); Manoharprasad K. Rao, Novi, MI (US)

(73) Assignee: Ford Global Technologies, LLC, Dearborn, MI (US)

(21) Appl. No.: 14/066,072

(22) Filed: Oct. 29, 2013

(51) Int. Cl. H04N 7/18; B60R 11/04

(52) U.S. Cl. CPC H04N 7/183; B60R 11/04
USPC 348/148

(57) ABSTRACT

An imaging and reporting system includes a wireless communication device having a user-installed program for forwarding a received image to a remote monitor and a vehicle-based network that includes an impact event sensing system, an imaging module including a camera for capturing an image of the vehicle's interior, and a transceiver for sending the captured image to the communication device. Operating software controls the imaging and reporting system. Thereafter the wireless communication device automatically forwards an image to the remote monitor that may be part of a community's 911 system. The operator reviews the one or more images received by the remote monitor and takes necessary action in response. The imaging and forwarding steps are accomplished without the need for human intervention. The software associated with the imaging and reporting system and the software associated with the wireless communication device disallows the retention of any captured image.

### TECHNICAL FIELD

The disclosed inventive concept relates generally to vehicle impact event notification arrangements. More particularly, the disclosed inventive concept relates to a private and automatic transmission of the photograph of a vehicle interior via an occupant's cell phone following an impact event.

### BACKGROUND OF THE INVENTION

As the use of wireless communication expands generally more and more vehicles are connecting through wireless systems as well. A number of arrangements are currently available for in-vehicle wireless communication. These arrangements include the vehicle operator or occupant communicating with the vehicle and the vehicle communicating with a remote monitoring location where the data can be reviewed by emergency personnel.

An example of the former arrangement is the use of a smartphone or similar communication device by a vehicle operator or occupant to communicate with the vehicle by controlling one or more vehicle functions. Alternatively or in addition the vehicle operator or occupant is able to stream music to the vehicle's audio system using a smartphone or similar communication device.

An example of the latter arrangement is a vehicle communication transmission device associated with the vehicle that handles telematic telecommunication duties. Such duties include, for example, signaling a remote receiver in the event of an impact event or a vehicle theft. These communication devices may be embedded in the vehicle or may be a cell phone that is in communication with the vehicle's system, such as Ford's SYNC® system that allows connection with available hands-free entertainment and communications.

As a next step in the ever-expanding scope of wireless vehicle communications greater effort is being focused on vehicle-originated communications in emergency situations. This is particularly the case where no vehicle occupant is able to communicate either the condition of a passenger or of the vehicle in an impact event. In such an instance it is desirable to display the condition of the vehicle and its occupants in real time for a remote receiver to observe the post-impact event status of the vehicle and its occupants and to take necessary action.

Communication devices that are not embedded in the vehicle, such as personal cellular devices, will not succeed in sending a photograph to the remote monitor unless someone in the vehicle is in condition to send the image and this may not always be the case. In those instances where an image can be sent, either through an embedded system or through a hand held device, it may not always be desirable because of several reasons, not the least of which including privacy concerns, for a photograph to be maintained in the memory of any device or system.

As in so many areas of vehicle technology there is always room for improvement related to the use and operation of communication devices for vehicles.

### SUMMARY OF THE INVENTION

The disclosed inventive concept provides a solution to the challenges associated with the broadcast of emergency information while maintaining privacy. The inventive concept proposes an imaging and reporting system that includes a wireless communication device having a program for forwarding a received image to a remote monitor and a vehicle-based network that includes a sensor for sensing an impact event, an imaging module associated with the sensor for capturing an image of the vehicle's interior, and a transceiver associated with the imaging module for forwarding one or more captured images to the communication device. Operating software is provided that controls the imaging and reporting system.

Thereafter the wireless communication device, being previously programmed by the operator, automatically forwards the one or more images to the remote monitor that may be part of a community's 911 system. The operator reviews the one or more images received by the remote monitor and takes necessary action in response. The imaging and forwarding steps are accomplished without the need for human intervention.

The system additionally includes a restraint control module for receiving notification of an impact event from the sensing system. The imaging module monitors the controller area network bus for an impact event notification signal generated by the restraint control module.

The imaging module includes a camera and an electronic control unit. The imaging module includes operating software for capturing an image and for forwarding the image to the transceiver. More than one imaging module may be provided, thus more than one camera may be provided.

The wireless communication device includes operator-installed and activated software. The software associated with the imaging and reporting system and the software associated with the wireless communication device disallows the retention of any captured image.

The above advantages and other advantages and features will be readily apparent from the following detailed description of the preferred embodiments when taken in connection with the accompanying drawings.

### BRIEF DESCRIPTION OF THE DRAWINGS

For a more complete understanding of this invention, reference should now be made to the embodiments illustrated in greater detail in the accompanying drawings and described below by way of examples of the invention wherein:

FIG. 1 illustrates view of a vehicle interior showing the primary components of the disclosed inventive concept; and

FIG. 2 depicts s a flow diagram that illustrates an exemplary illustrative method for executing the image preparing and forwarding functions of the vehicle-based system of the disclosed inventive concept.

### DETAILED DESCRIPTION OF THE PREFERRED EMBODIMENT

In the following figures, the same reference numerals will be used to refer to the same components. In the following description, various operating parameters and components are described for different constructed embodiments. These specific parameters and components are included as examples and are not meant to be limiting.

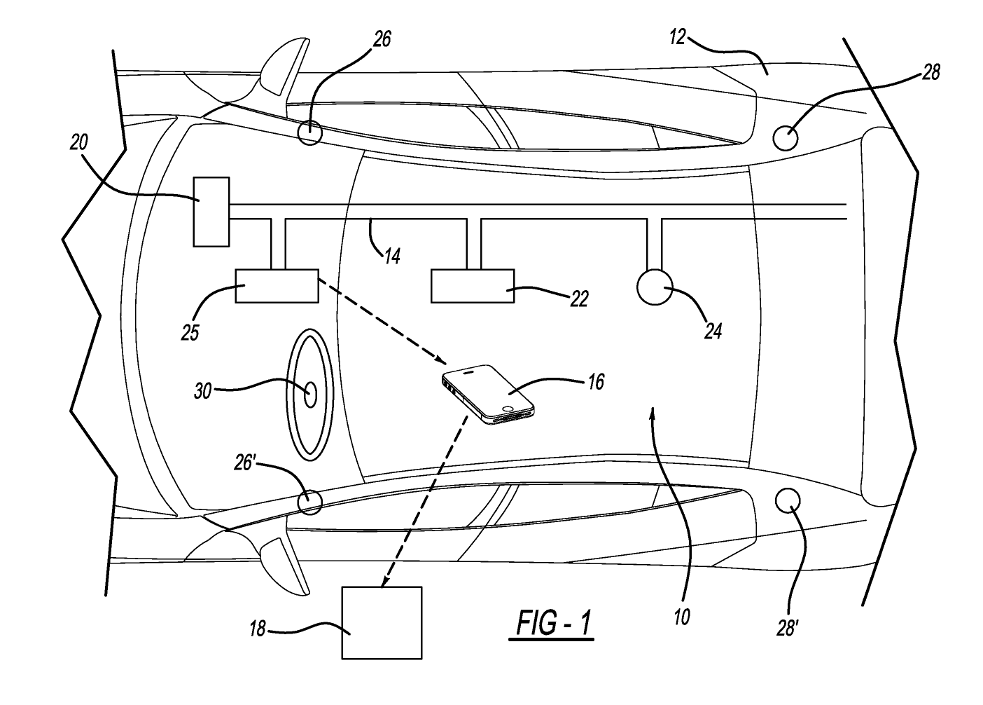

The disclosed inventive concept may find application in any number of vehicles, including automotive vehicles and trucks. FIG. 1 illustrates a view of an automotive vehicle interior, generally illustrated as 10, of a vehicle 12 showing the primary components of the disclosed inventive concept. It is to be understood that while an automotive vehicle interior is illustrated the disclosed inventive concept may also find application in any other situation where a passenger may be unable to respond and an image of the passenger's environment would be useful to a remote emergency service in determining the required level of response.

The vehicle 12 includes an embedded imaging and forwarding network 14 that includes a wireless communication device such as a cell phone 16. The cell phone 16 may be the driver's phone or a passenger's phone. The cell phone 16 is not itself embedded in the vehicle. The user of the cell phone 16 selectively downloads an appropriate program or app that allows the cell phone 16 to be used in conjunction with the imaging and forwarding network 14. Accordingly, data including images sent from another source would not be automatically accepted by the cell phone 16 due to security concerns.

The program or app works in conjunction with the software of the cell phone 16 to receive an image from the imaging and forwarding network 14 and to send the image to a remote receiver 18 without retaining the forwarded image(s). The image receiver 18 is an emergency call center which may be a community's 911 call center.

The embedded imaging and forwarding network 14 includes a controller area network (CAN) bus 20 or other system that includes microcontrollers and other devices that are able to communicate within the vehicle 12 without the need for a host computer. The CAN bus 20 monitors the network 14 for a signal from a restraint control module (RCM) 22 confirming that an impact event has occurred.

If the CAN bus 20 receives an impact event notification from the RCM 22 then an imaging capturing device 24 that includes an imaging module and a device such as a wide angle camera captures an image of the vehicle interior 10. The captured image is then transmitted by a transceiver 25 to the cell phone 16 which then forwards the received image to the image receiver 18.

The embedded imaging and forwarding network 14 incorporates software that, like the software of the cell phone 16, forwards the image(s) without their being retained. Variations of the imaging and forwarding network 14 include additional image capturing devices 26 and 26′ provided on the A-pillars of the vehicle 12. Image capturing devices 28 and 28′ may also be provided in conjunction with other pillars, such as the C-pillars. As a further variation an image capturing device 30 may be fitted to the driver-facing side of the steering wheel. Image capturing devices may also be provided in conjunction with other interior components, such as on the back sides of the front seat headrests (not shown).

In addition, the cell phone operator can selectively pre-load a text message into the cell phone 16 that accompanies the forwarded images. A message such as “send help” would be suitable for such a situation. The message may also include information related to special health or medical conditions of the cell phone owner.

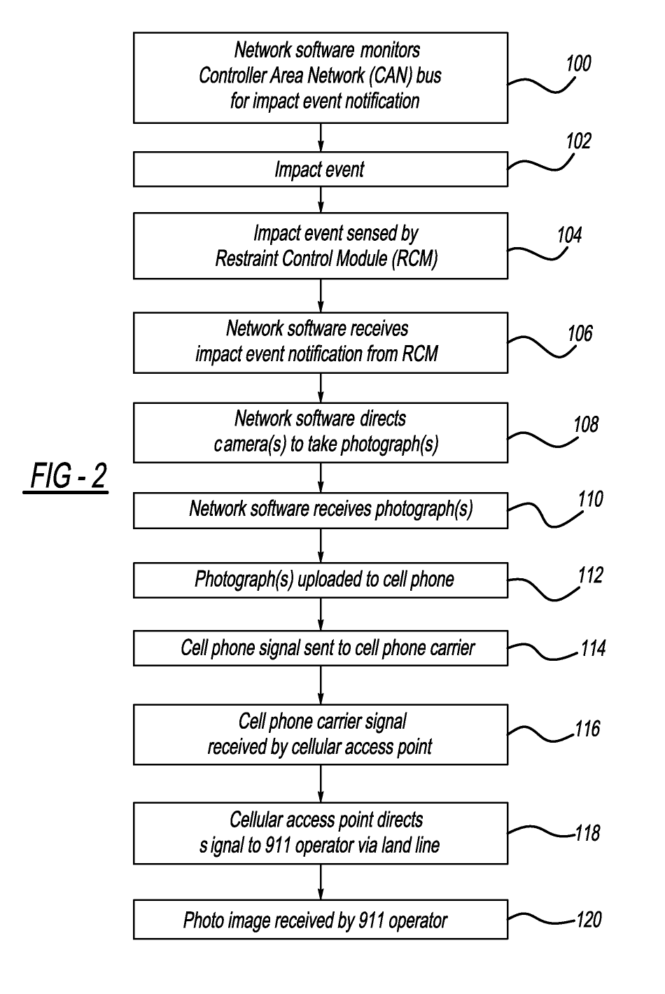

A summary of the steps of the disclosed inventive concept from prior to an impact to the receipt of an image by an emergency operator taken following an impact event is set forth in FIG. 2. According to this figure, a flow diagram illustrates an exemplary illustrative method for executing the image preparing and forwarding functions of the vehicle-based system of the disclosed inventive concept.

At step 100 the controller area network (CAN) bus 20 is actively monitored for an impact event notification. If an impact event occurs at step 102 the event is sensed by the restraint control module (RCM) 22 at step 104. The network software receives notification of the impact event at step 106 from the RCM 22.

At step 108 the image capturing device 24 (or one or more of additional imaging capturing devices 26, 26′, 28, 28′ and 30) captures an image. The image captured is received by the network software at step 110. At step 112 the image is sent by the transceiver 25 to the cell phone 16.

Once the image is received by the cell phone 16 at step 112 the image is thereafter forwarded to the cell phone carrier at step 114. As is understood in the art the cell phone carrier signal containing the image is received by a cellular access point at step 116.

At step 118 the cellular access point that received the signal sent to it in step 116 is directed to the emergency operator, such as a 911 operator, via a land line as is conventionally known. Finally at step 120 the image is received by the emergency operator who can interpret the received image and instruct that an appropriate emergency response be undertaken.

It is to be understood that while the discussion above with respect to steps 100-120 references a single image more than one image may be generated and forwarded to the emergency operator. The messages may also be sent from the cellular access point to any other designated receivers via wired or wireless means.

The system represented above according to the disclosed inventive concept offers several advantages over known arrangements. First, the system eliminates the need for human intervention. Once an impact event is sensed by the network, an image is captured and is forwarded automatically to the wireless device which, in turn forwards the capture image to the emergency operator. Second, the steps of sensing an impact event, capturing an image, and forwarding the image to the wireless device are made in milliseconds. Given this speed even if the vehicle were to suffer a power failure the necessary image would be successfully forwarded before the power failure impacted the network. A battery back-up could also be attached to the network.

Another advantage of the system according to the disclosed inventive concept is that the network can be incorporated into existing systems, such as Ford's SYNC® system thus saving both cost and weight. Finally, and very importantly, the system disclosed herein is specifically directed to maintaining the privacy of the vehicle operator and passenger by disallowing the retention of any image captured and forwarded to the emergency operator.

For at least the above reasons the disclosed invention as set forth above overcomes the challenges faced by known emergency notification systems for vehicles. However, one skilled in the art will readily recognize from such discussion, and from the accompanying drawings and claims that various changes, modifications and variations can be made therein without departing from the true spirit and fair scope of the invention as defined by the following claims.

What is claimed is:

1. An imaging and reporting system comprising:
a wireless communication device having a program for forwarding a received image to a remote monitor; and
a vehicle having an interior and a vehicle-based network that includes a sensing system for sensing an impact event, an imaging module associated with said sensing system for capturing an image of said interior, and a transceiver associated with said imaging module for forwarding said captured image to said communication device.

2. The imaging and reporting system of claim 1 further including a restraint control module for receiving notification of an impact event from said sensing system.

3. The imaging and reporting system of claim 2 wherein said restraint control module and said sensing system are on a controller area network bus.

4. The imaging and reporting system of claim 3 wherein said imaging module monitors a controller area network bus for an impact event notification signal from said restraint control module.

5. The imaging and reporting system of claim 1 wherein said imaging module includes a camera.

6. The imaging and reporting system of claim 5 wherein said imaging module includes operating software for capturing an image and for forwarding said image to said transceiver.

7. The imaging and reporting system of claim 6 wherein said imaging module includes a camera control unit.

8. The imaging and reporting system of claim 1 wherein said wireless communication device includes operator-installed and activated software.

9. The imaging and reporting system of claim 1 wherein neither said wireless communication device nor said vehicle-based network retains a captured image.

10. A vehicle having a vehicle-based imaging and reporting system for use with a wireless communication device, the system comprising:
a vehicle interior;
an imaging and reporting network associated with the vehicle, said network including a sensing system for sensing an impact event, an imaging module associated with said sensing system for capturing an image of said interior, and a transceiver associated with said module for forwarding said captured image to the wireless communication device.

11. The vehicle of claim 10 further including a restraint control module for receiving notification of an impact event from said sensing system.

12. The vehicle of claim 11 wherein said restraint control module and said sensing system are on a controller area network bus.

13. The vehicle of claim 12 wherein said imaging module monitors a controller area network bus for an impact event notification signal from said restraint control module.

14. The vehicle of claim 10 wherein said imaging module includes a camera.

15. The vehicle of claim 14 wherein said imaging module includes operating software for capturing an image and for forwarding said image to said transceiver.

16. The vehicle of claim 15 wherein said imaging module includes a camera control unit.

17. The vehicle of claim 10 wherein no captured image is retained by said network.

18. A method for use with a vehicle for capturing and forwarding an image to a remote receiver following an impact event, comprising the steps of:
forming a vehicle-embedded network comprising an impact sensing system and an imaging device;
sensing an impact event by said impact sensing system;
capturing the image with said imaging device;
forwarding said image to a wireless communication device without retaining said image;
and
forwarding said image to the receiver without retaining said image.

19. The method of claim 18 including the step of providing said network and said wireless communication device with software that disallows the retention of said image.

20. The method of claim 18 including the step of pre-programming said wireless communication device with a message to be sent to said receiver in conjunction with said image.
